(19) United States
(12) Patent Application Publication
(10) Pub. No.: US 2007/0294540 A1
(43) Pub. Date: Dec. 20, 2007

(54) Biometric data update system

(75) Inventor: Yutaka Wadayama, Gunma (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/808,170

(22) Filed: Jun. 7, 2007

(30) Foreign Application Priority Data
Jun. 20, 2006 (JP) JP2006-170449

(51) Int. Cl. H04K 1/00

(52) U.S. Cl. 713/186

(57) ABSTRACT

When a biometric authentication is determined to be successful, non-match rate data, which represents a rate of non-match between biometric data acquired from a user and registered biometric data acquired from an authentication card, is compared with update threshold data, which represents a rate of non-match between the biometric data and the registered biometric data that is a standard for updating the registered biometric data acquired from the authentication card. If the non-match rate data is larger than the update threshold data, it is determined that an update is necessary, and the registered biometric data retained at the authentication card is updated on the basis of the acquired biometric data.

### CROSS-REFERENCE TO RELATED APPLICATION

This application claims priority under 35 USC 119 from Japanese Patent Application No. 2006-170449, the disclosure of which is incorporated by reference herein.

### BACKGROUND OF THE INVENTION

1. Field of the Invention

The present invention relates to a biometric data update system which, in order to prevent proper biometric authentication becoming impossible due to changes with aging that arise in a biometric characteristic of a user, compares biometric data, which represents the biometric characteristic of the user, with registered biometric data, which has been registered beforehand, and if a successful biometric authentication is determined, updates the registered biometric data in accordance with the biometric data. More particularly, the present invention relates to a biometric data update system capable of suitably updating registered biometric data when changes with aging arise in biometric characteristics of users.

2. Description of the Related Art

Biometric data update systems are known which update registered biometric data which has been registered beforehand in order to prevent proper biometric authentication becoming impossible due to a change with aging occurring in a biometric characteristic of a user. For example, Japanese Patent Application Laid-Open (JP-A) No. 2002-298202 has disclosed a biometric data update system which compares registered biometric data of a user, which has been registered at an IC card beforehand, with biometric data representing a biometric characteristic of the user, which is acquired from a biometric sensor or the like, and if biometric authentication is determined to be successful, updates the registered biometric data in accordance with the acquired biometric data.

However, with the biometric data update system described above, in order to prevent proper biometric authentication becoming impossible due to changes that arise in the biometric characteristic of a user with aging, an update of the registered biometric data is carried out in accordance with the acquired biometric data each time biometric authentication is determined to be successful. Therefore, even when no change with aging has arisen in the biometric characteristic of the user, unnecessary updates of the registered biometric data are being carried out.

### SUMMARY OF THE INVENTION

The present invention has been made in view of the above circumstances and provides a biometric data update system.

According to an aspect of the invention, there is provided a biometric data update system that generates non-match rate data representing a rate of non-match between biometric data and registered biometric data, the biometric data representing a biometric characteristic of a user and the registered biometric data having been registered in advance as a matching object, and determines that biometric authentication is successful if the non-match rate data is smaller than authentication threshold data which represents a non-match rate that is a standard for success of the biometric authentication between the biometric data and the registered biometric data, the system comprising: an authentication card that retains at least the registered biometric data and update threshold data, the update threshold data representing the non-match rate between the biometric data and the registered biometric data; a reading section that acquires the registered biometric data and the update threshold data from the authentication card; an update necessity determination section that, if the biometric authentication is determined to be successful, compares the non-match rate data with the acquired update threshold data and, if the non-match rate data is larger than the update threshold data, determines that an update is necessary; and an update section that, if the update is determined to be necessary, updates the registered biometric data retained at the authentication card on the basis of the acquired biometric data.

### BRIEF DESCRIPTION OF THE DRAWINGS

Preferred embodiments of the present invention will be described in detail based on the following figures, wherein:

FIG. 1 is a block structural diagram showing an automatic trading system of a first embodiment in which the present invention is applied;

FIG. 2 is an operation flowchart of the automatic trading system of the first embodiment;

FIG. 3 is a block structural diagram showing an automatic trading system of a second embodiment in which the present invention is applied;

FIG. 4 is an operation flowchart of the automatic trading system of the second embodiment;

FIG. 5 is a block structural diagram showing an automatic trading system of a third embodiment in which the present invention is applied;

FIG. 6 is an operation flowchart of the automatic trading system of the third embodiment;

FIG. 7 is a block structural diagram showing an automatic trading system of a fourth embodiment in which the present invention is applied; and

FIG. 8 is an operation flowchart of the automatic trading system of the fourth embodiment.

### DETAILED DESCRIPTION OF THE INVENTION

Herebelow, an embodiment of the present invention will be described in detail using the drawings.

### First Embodiment

### Structure of the First Embodiment

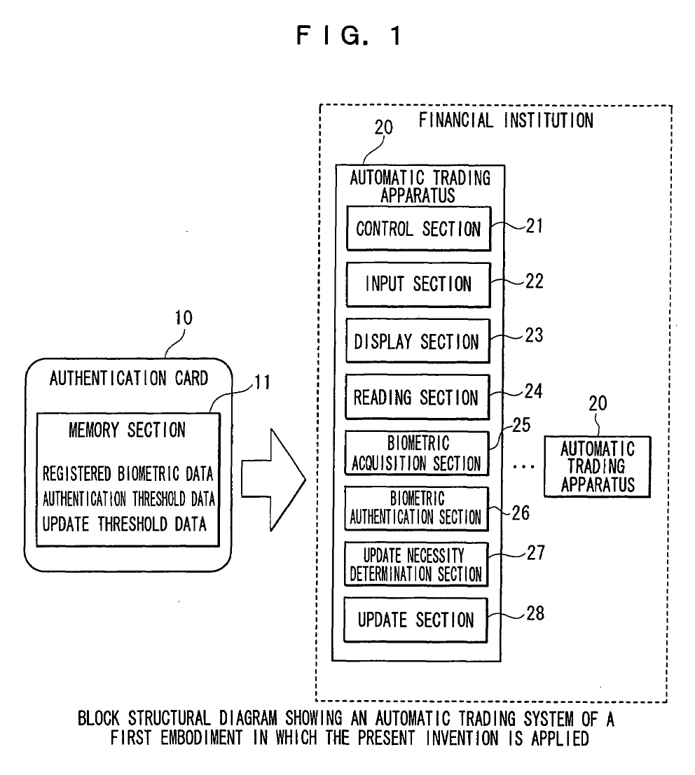

FIG. 1 is a block structural diagram showing an automatic trading system of the first embodiment in which the present invention is applied.

As shown in FIG. 1, the automatic trading system of the first embodiment is structured with an authentication card 10 and a plurality of automatic trading apparatuses 20 that are disposed in financial institutions and suchlike.

The authentication card 10 is an IC card which is required for performing biometric authentication, and includes a memory section 11.

The memory section 11 is, for example, a memory formed with a hard disk drive or the like, and retains registered biometric data which represents a biometric characteristic such as a vein pattern or the like of a user, which was registered when the IC card was issued, and retains authentication threshold data and update threshold data.

The authentication threshold data is data representing a rate of non-match between biometric data and the registered biometric data that is a standard for success in biometric authentication. The update threshold data is data representing a non-match rate between the biometric data and the registered biometric data that is a standard for an update of the registered biometric data being required. The authentication threshold data and update threshold data are obtained by experiment at a design stage. In the present embodiment, the registered biometric data is data representing a characteristic of veins in the palm of a hand of a user. However, it is not limited to this. The biometric data could be any kind of data that represents a biometric characteristic of the user, such as, for example, a fingerprint, an iris, the face or the like.

The automatic trading apparatus 20 is disposed at a financial institution or the like, and is a device which performs biometric authentication of users and performs required trading processing, such as depositing money or the like, for users for whom biometric authentication is successful. The automatic trading apparatus 20 includes a control section 21, an input section 22 formed with a touch panel or the like, a display section 23 formed with a liquid crystal display or the like, a reading section 24, a biometric acquisition section 25, a biometric authentication section 26, an update necessity determination section 27 and an update section 28.

The control section 21, which may be what is referred to as a CPU, is a section which performs overall control of the automatic trading apparatus 20. An unillustrated memory retains each of data of a trading selection screen, at which details of trading such as deposits and the like are instructed by selections by a user, data of an insertion instruction screen, for instructing the user to insert the authentication card 10, data of a biometric acquisition instruction screen, which instructs the user for acquisition of biometric data, and data of a biometric authentication failure screen, for displaying when biometric authentication has failed.

As an initial screen, the control section 21 causes the trading selection screen to be displayed at the display section 23 in accordance with the trading selection screen data in the memory. The user refers to the trading selection screen and selects desired details of trading via the input section 22. In response, the control section 21 causes the insertion instruction screen to be displayed at the display section 23 in accordance with the insertion instruction screen data in the memory.

The reading section 24 is a section, such as, for example, an IC card reader/writer or the like, which acquires registered biometric data and the like of the user from the authentication card 10 that is inserted thereat. The user refers to the insertion instruction screen and inserts the authentication card 10 at the reading section 24, and the reading section 24 reads the inserted authentication card 10 and acquires each of the registered biometric data, the authentication threshold data and the update threshold data from the memory section 11.

When the reading section 24 acquires the registered biometric data, the authentication threshold data and the update threshold data, the control section 21 temporarily stores the acquired sets of data at an unillustrated memory. The control section 21 causes the display section 23 to display the biometric acquisition instruction screen in accordance with the biometric acquisition instruction screen data in the memory, in order to acquire biometric data from the user.

The user refers to the biometric acquisition instruction screen, places their palm at the predetermined position, and instructs acquisition of the biometric data via the input section 22. In response, the control section 21 outputs a biometric acquisition instruction signal to the biometric acquisition section 25.

The biometric acquisition section 25 is a section, such as, for example, a biometric sensor or the like, which acquires biometric data representing a biometric characteristic such as a vein pattern or the like from the user. When the biometric acquisition section 25 receives the biometric acquisition instruction signal, the biometric acquisition section 25 acquires biometric data representing a vein pattern characteristic from the palm of the user which has been placed at the predetermined position.

In the present embodiment, the biometric acquisition section 25 is structured to acquire biometric data representing a characteristic of veins in a palm of the user. However, it is not limited to this. Any kind of data can be used that represents a biometric characteristic of the user, such as, for example, a fingerprint, an iris scan, facial structure or the like.

The biometric authentication section 26 is a section which performs biometric authentication of the user. When the biometric acquisition section 25 has acquired the biometric data, the biometric authentication section 26 compares the acquired biometric data with the registered biometric data in the memory, and generates data of a rate of non-match which represents a rate of non-match between the two sets of data. If the generated non-match rate data is smaller than the authentication threshold data, a biometric authentication success is determined, but if larger, a biometric authentication failure is determined.

When the biometric authentication section 26 determines a biometric authentication failure, the control section 21 causes the biometric authentication failure screen to be displayed at the display section 23 in accordance with the biometric authentication failure screen data in the memory.

On the other hand, when the biometric authentication section 26 determines a biometric authentication success, the control section 21 outputs a determination instruction signal to the update necessity determination section 27, to cause the update necessity determination section 27 to determine an update necessity of the registered biometric data.

The update necessity determination section 27 is a section which determines whether or not registered biometric data needs updating. When the update necessity determination section 27 receives the determination instruction signal, the update necessity determination section 27 compares the generated non-match rate data with the update threshold data in the memory. If the non-match rate data is larger than the update threshold data, an update is determined to be necessary, but if smaller, an update is determined to be unnecessary.

If the update necessity determination section 27 determines that an update is unnecessary, the control section 21 outputs a trading commencement signal instructing commencement of trading to an unillustrated trading section. Trading processing is executed by the trading section that has received the trading commencement instruction on the basis of information representing the trading details that have been selected, similarly to heretofore.

On the other hand, if the update necessity determination section 27 determines that an update is necessary, the control section 21 outputs an update instruction signal, with the biometric data appended, to the update section 28 in order to update the registered biometric data retained at the memory section 11 of the authentication card 10.

The update section 28 is a section which performs an update of the registered biometric data retained in the memory section 11 of the authentication card 10. When the update section 28 receives the update instruction signal, the update section 28 updates the registered biometric data in the memory section 11 in accordance with the appended biometric data.

When the update section 28 completes the update processing, the control section 21 outputs the trading commencement signal instructing commencement of trading to the unillustrated trading section, in the same manner as described above. Trading processing is executed by the trading section that has received the trading commencement instruction on the basis of information representing the trading details that have been selected, similarly to heretofore.

### Operation of the First Embodiment

Below, operation of the automatic trading system of the first embodiment will be described.

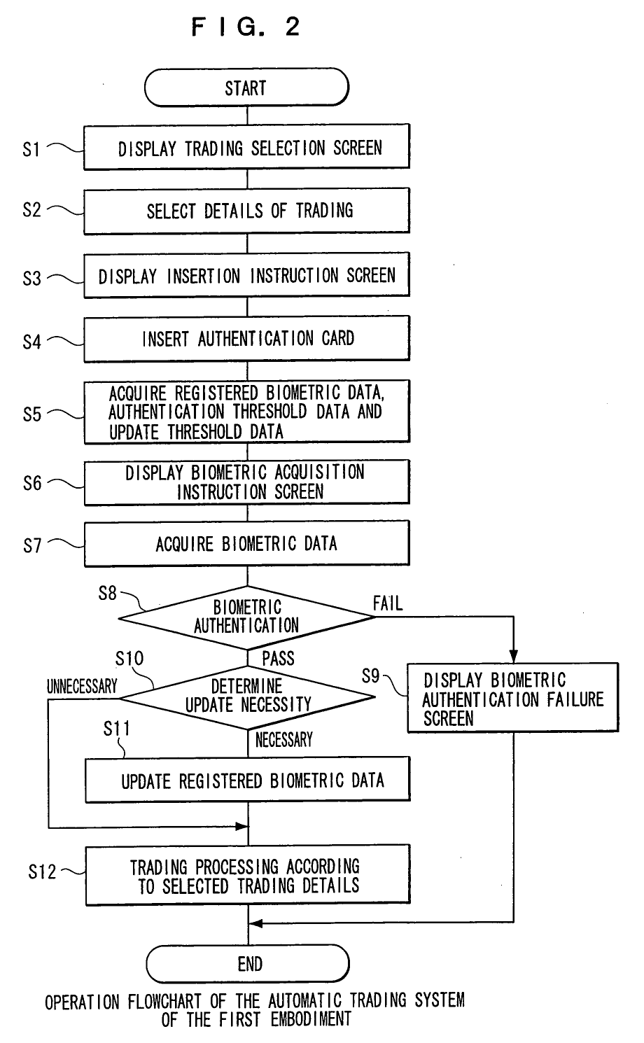

FIG. 2 is an operation flowchart of the automatic trading system of the first embodiment.

The control section 21 of the automatic trading apparatus 20 causes the trading selection screen to be displayed at the display section 23 as an initial screen, in accordance with the trading selection screen data in the memory (S1).

The user refers to the trading selection screen and selects desired trading details via the input section 22 (S2). In response, the control section 21 causes the insertion instruction screen to be displayed at the display section 23 in accordance with the insertion instruction screen data in the memory (S3).

The user refers to the insertion instruction screen and inserts the authentication card 10 at the reading section 24 (S4). In response, the reading section 24 reads the inserted authentication card 10 and acquires each of the registered biometric data, the authentication threshold data and the update threshold data from the memory section 11 (S5).

When the reading section 24 acquires the registered biometric data, etc., the control section 21 temporarily stores the acquired registered biometric data, authentication threshold data and update threshold data in an unillustrated memory. In order to instruct the user for acquisition of biometric data, the biometric acquisition instruction screen is displayed at the display section 23 in accordance with the biometric acquisition instruction screen data in the memory (S6).

The user refers to the biometric acquisition instruction screen, places their palm at the predetermined position, and gives an instruction for the acquisition of biometric data via the input section 22. In response, the control section 21 outputs the biometric acquisition instruction signal to the biometric acquisition section 25.

When the biometric acquisition section 25 receives the biometric acquisition instruction signal, the biometric acquisition section 25 acquires biometric data representing a vein characteristic from the palm of the user which has been set at the predetermined position (S7).

When the biometric acquisition section 25 has acquired the biometric data, the biometric authentication section 26 compares the acquired biometric data with the registered biometric data in the memory, and generates the non-match rate data representing a rate of non-match between the two sets of data. If the non-match rate data that is generated is larger than the authentication threshold data, the biometric authentication is determined to be failed, and if smaller, the biometric authentication is determined to be successful (S8).

If the biometric authentication section 26 determines a biometric authentication failure, the control section 21 causes the biometric authentication failure screen to be displayed at the display section 23 in accordance with the biometric authentication failure screen data in the memory (S9).

On the other hand, if a biometric authentication success is determined, the control section 21 outputs the determination instruction signal to the update necessity determination section 27, to determine an update necessity for the registered biometric data.

When the update necessity determination section 27 receives the determination instruction signal, the update necessity determination section 27 compares the non-match rate data that has been generated with the update threshold data in the memory. If the non-match rate data is larger than the update threshold data, an update is determined to be necessary, and if smaller, an update is determined to be unnecessary (S10).

If the update necessity determination section 27 determines that an update is unnecessary, the control section 21 outputs the trading commencement signal instructing commencement of trading to the unillustrated trading section. Consequent to the trading section receiving the trading commencement signal, trading processing is executed in accordance with information representing the selected trading details, similarly to heretofore (S12).

On the other hand, if the update necessity determination section 27 determines that an update is necessary, the control section 21 outputs the update instruction signal to the update section 28, with the biometric data appended, in order to update the registered biometric data stored at the memory section 11 of the authentication card 10.

When the update section 28 receives the update instruction signal, the update section 28 updates the registered biometric data at the memory section 11 on the basis of the appended biometric data (S11).

When the update section 28 has finished the update processing, the control section 21 outputs the trading commencement signal instructing commencement of trading to the unillustrated trading section in the same manner as described above. Consequent to the trading section receiving the trading commencement signal, trading processing is executed in accordance with information representing the selected trading details, similarly to heretofore (S12).

### Effects of the First Embodiment

In the automatic trading system of the first embodiment, when the biometric authentication is determined to be successful, non-match rate data, which represents a rate of non-match between biometric data acquired from a user and registered biometric data acquired from the authentication card 10, is compared with update threshold data, which represents a non-match rate between the biometric data and the registered biometric data that is a standard for updating the registered biometric data acquired from the authentication card 10. If the non-match rate data is larger than the update threshold data, an update is determined to be necessary and the registered biometric data retained at the authentication card is updated on the basis of the acquired biometric data. Thus, the registered biometric data can be updated only when there is a large change with aging. Therefore, unnecessary updating of the registered biometric data can be prevented.

### Second Embodiment

### Structure of the Second Embodiment

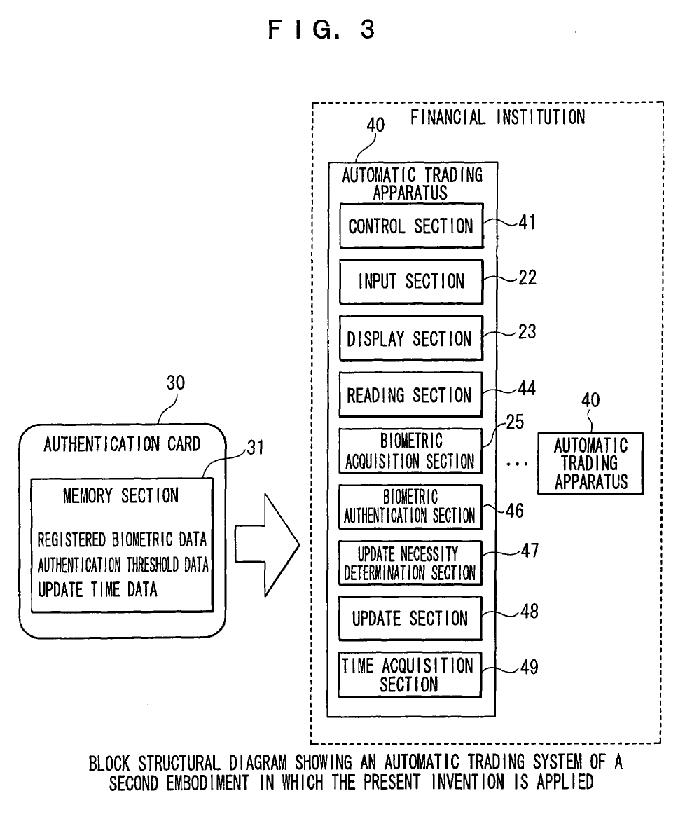

FIG. 3 is a block structural diagram showing an automatic trading system of the second embodiment in which the present invention is applied.

As shown in FIG. 3, the automatic trading system of the second embodiment is structured with an authentication card 30 and automatic trading apparatuses 40.

The authentication card 30 is an IC card which is required for performing biometric authentication, and includes a memory section 31.

The memory section 31 is, for example, a memory formed with a hard disk drive or the like, and retains registered biometric data which represents a biometric characteristic such as a vein pattern or the like of a user, which was registered when the IC card was issued, and retains authentication threshold data and update time data.

The authentication threshold data is authentication threshold data representing a non-match rate between biometric data and the registered biometric data that is a standard for success in biometric authentication. The authentication threshold data is obtained by experiment at the design stage. The update time data is data representing the most recent date and time that the registered biometric data was retained to the memory section 31.

In the present embodiment, the registered biometric data is data representing a characteristic of veins in the palm of a hand of a user. However, it is not limited to this. The biometric data could be any kind of data that represents a biometric characteristic of the user, such as, for example, a fingerprint, an iris, the face or the like.

The automatic trading apparatus 40 is disposed at a financial institution or the like, and is a device which performs biometric authentication of users and performs required trading processing, such as deposits and the like, for users for whom biometric authentication is successful. The automatic trading apparatus 40 includes a control section 41, the input section 22 formed with a touch panel or the like, the display section 23 formed with a liquid crystal display or the like, a reading section 44, the biometric acquisition section 25, a biometric authentication section 46, an update necessity determination section 47, an update section 48 and a time acquisition section 49. The input section 22, the display section 23 and the biometric acquisition section 25 are the same as in the first embodiment.

The reading section 44 is a section, such as, for example, an IC card reader/writer or the like, which acquires registered biometric data and the like of the user from the authentication card 30 that is inserted thereat. The user refers to an insertion instruction screen and inserts the authentication card 30 at the reading section 44, and the reading section 44 reads the inserted authentication card 30 and acquires each of the registered biometric data, the authentication threshold data and the update time data from the memory section 31.

The control section 41, being a CPU, is a section which performs overall control of the automatic trading apparatus 40. When the reading section 44 acquires the registered biometric data, etc. as described above, the control section 41 temporarily stores the acquired sets of data at an unillustrated memory.

The biometric authentication section 46 is a section which performs biometric authentication of the user. When the biometric acquisition section 25 has acquired biometric data in a similar manner to the first embodiment, the biometric authentication section 46 compares the acquired biometric data with the registered biometric data in the memory, and generates non-match rate data which represents a rate of non-match between the two sets of data. If the generated non-match rate data is smaller than the authentication threshold data, a biometric authentication success is determined, but if larger, a biometric authentication failure is determined.

When the biometric authentication section 46 determines a biometric authentication failure, the control section 41 causes a biometric authentication failure screen to be displayed at the display section 23 in accordance with biometric authentication failure screen data in the memory.

On the other hand, when the biometric authentication section 46 determines a biometric authentication success, the control section 41 outputs a determination instruction signal to the update necessity determination section 47, to cause the update necessity determination section 47 to determine an update necessity of the registered biometric data.

The update necessity determination section 47 is a section which determines whether or not the registered biometric data needs updating. Update interval data, which represents an interval of elapsed time that is a standard for the necessity of updating the registered biometric data, is retained in an unillustrated memory. Here, this update interval data is data obtained by experiment at the design stage.

When the update necessity determination section 47 receives the determination instruction signal, the update necessity determination section 47 first outputs a time acquisition instruction signal to the time acquisition section 49, in order to acquire the current date and time.

The time acquisition section 49 is a section which generates current time data representing the current date and time. When the time acquisition section 49 receives the time acquisition instruction signal, the time acquisition section 49 generates the current time data on the basis of a date and time indicated by a built-in clock.

Then, when the time acquisition section 49 has generated the current time data, the update necessity determination section 47 generates elapsed duration data, representing a duration from the date and time of a previous update to the current date and time, on the basis of the current time data and the update time data in the memory. If the generated elapsed duration data is larger than the update interval data in the memory, it is determined that an update is necessary, but if smaller, it is determined that an update is unnecessary.

If the update necessity determination section 47 determines that an update is unnecessary, the control section 41 outputs a trading commencement signal instructing commencement of trading to an unillustrated trading section, in the same manner as in the first embodiment. Trading processing is executed by the trading section that has received the trading commencement instruction on the basis of information representing trading details that have been selected, similarly to heretofore.

On the other hand, if the update necessity determination section 47 determines that an update is necessary, the control section 41 outputs an update instruction signal, with the biometric data and the current time data appended, to the update section 48 in order to update the registered biometric data and the update time data retained at the memory section 31 of the authentication card 30.

The update section 48 is a section which performs an update of the registered biometric data and update time data retained in the memory section 31 of the authentication card 30. When the update section 48 receives the update instruction signal, the update section 48 updates the registered biometric data at the memory section 31 in accordance with the appended biometric data, and updates the update time data in accordance with the current time data. Thereafter, operations are the same as for the first embodiment.

### Operation of the Second Embodiment

Below, operation of the automatic trading system of the second embodiment will be described.

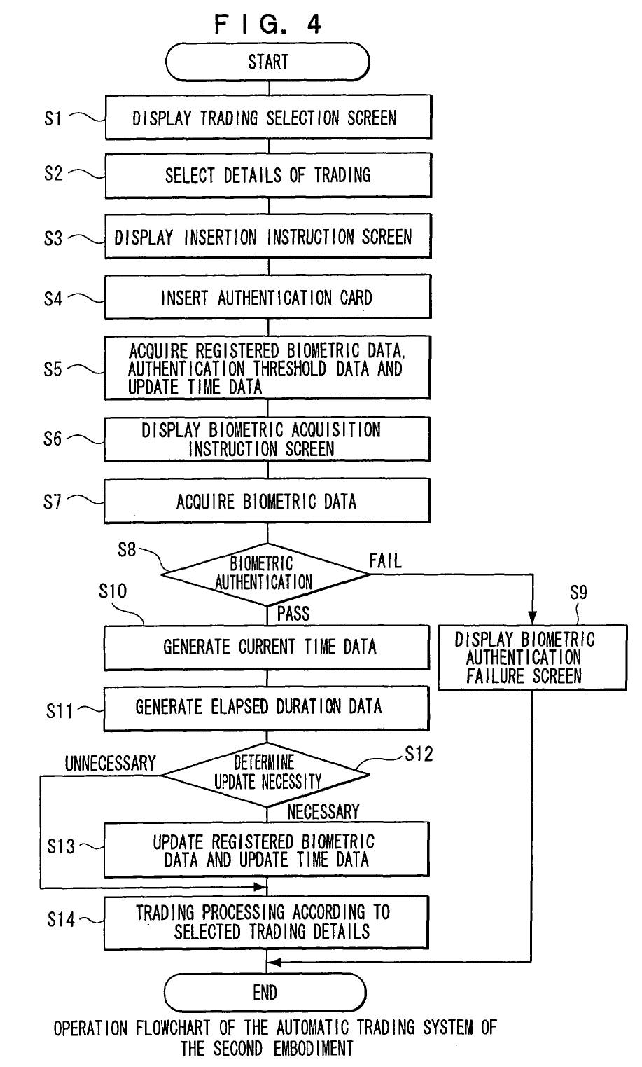

FIG. 4 is an operation flowchart of the automatic trading system of the second embodiment.

The control section 41 of the automatic trading apparatus 40 causes a trading selection screen to be displayed at the display section 23 as an initial screen, in accordance with trading selection screen data in the memory (S1).

The user refers to the trading selection screen and selects desired trading details via the input section 22 (S2). In response, the control section 41 causes the insertion instruction screen to be displayed at the display section 23 in accordance with insertion instruction screen data in the memory (S3).

The user refers to the insertion instruction screen and inserts the authentication card 30 at the reading section 44 (S4). In response, the reading section 44 reads the inserted authentication card 30 and acquires each of the registered biometric data, the authentication threshold data and the update time (date and time) data from the memory section 31 (S5).

When the reading section 44 acquires each of the registered biometric data, the authentication threshold data and the update time data, the control section 41 temporarily stores the acquired registered biometric data, authentication threshold data and update time data in an unillustrated memory. In order to acquire biometric data from the user, a biometric acquisition instruction screen is displayed at the display section 23 in accordance with biometric acquisition instruction screen data in the memory (S6).

The user refers to the biometric acquisition instruction screen, places their palm at the predetermined position, and gives an instruction for the acquisition of biometric data via the input section 22. In response, the control section 41 outputs a biometric acquisition instruction signal to the biometric acquisition section 25.

When the biometric acquisition section 25 receives the biometric acquisition instruction signal, the biometric acquisition section 25 acquires biometric data representing a vein characteristic from the palm of the user which has been set at the predetermined position (S7).

When the biometric acquisition section 25 has acquired the biometric data, the biometric authentication section 46 compares the acquired biometric data with the registered biometric data in the memory, and generates the non-match rate data representing a rate of non-match between the two sets of data. If the non-match rate data that is generated is larger than the authentication threshold data, the biometric authentication is determined to be failed, and if smaller, the biometric authentication is determined to be successful (S8).

If the biometric authentication section 46 determines a biometric authentication failure, the control section 41 causes the biometric authentication failure screen to be displayed at the display section 23 in accordance with the biometric authentication failure screen data in the memory (S9).

On the other hand, if a biometric authentication success is determined, the control section 41 outputs the determination instruction signal to the update necessity determination section 47 to determine an update necessity for the registered biometric data.

When the update necessity determination section 47 receives the determination instruction signal, the update necessity determination section 47 first outputs the time acquisition instruction signal to the time acquisition section 49 in order to acquire the current time.

When the time acquisition section 49 receives the time acquisition instruction signal, the time acquisition section 49 generates the current time data representing the current date and time on the basis of the date and time indicated by the built-in clock (S10).

Then, when the time acquisition section 49 has generated the current time data, the update necessity determination section 47 generates the elapsed duration data, representing the duration from the time of the previous update to the current time, on the basis of the current time data and the update time data in the memory (S11). If the generated elapsed duration data is larger than the update interval data in the memory, an update is determined to be necessary, and if smaller, an update is determined to be unnecessary (S12).

If the update necessity determination section 47 determines that an update is unnecessary, the control section 41 outputs the trading commencement signal instructing commencement of trading to the unillustrated trading section, in the same manner as in the first embodiment. Trading processing is executed by the trading section that has received the trading commencement instruction, on the basis of information representing the trading details that have been selected, similarly to heretofore.

On the other hand, if the update necessity determination section 47 determines that an update is necessary, the control section 41 outputs the update instruction signal, with the biometric data and the current time data attached, to the update section 48 in order to update the registered biometric data and the update time data retained at the memory section 31 of the authentication card 30.

When the update section 48 receives the update instruction signal, the update section 48 updates the registered biometric data at the memory section 31 in accordance with the attached biometric data, and updates the update time data in accordance with the current time data (S13). Thereafter, operations are the same as in the first embodiment (S14).

### Effects of the Second Embodiment

In the automatic trading system of the second embodiment, when biometric authentication is determined to be successful, elapsed duration data, representing duration that has passed between an update time and the current time, is generated on the basis of update time data, which represents a time at which registered biometric data acquired from the authentication card 30 was retained thereto, and the current time. If the generated elapsed interval data is larger than update interval data, which represents an interval of elapsed time that is a standard for updating the registered biometric data, then an update is determined to be necessary, the registered biometric data retained at the authentication card is updated on the basis of acquired biometric data, and the update time data is updated on the basis of the current time data. Thus, the registered biometric data can be updated only when there is a large change with aging. Therefore, unnecessary updating of the registered biometric data can be prevented.

### Third Embodiment

### Structure of the Third Embodiment

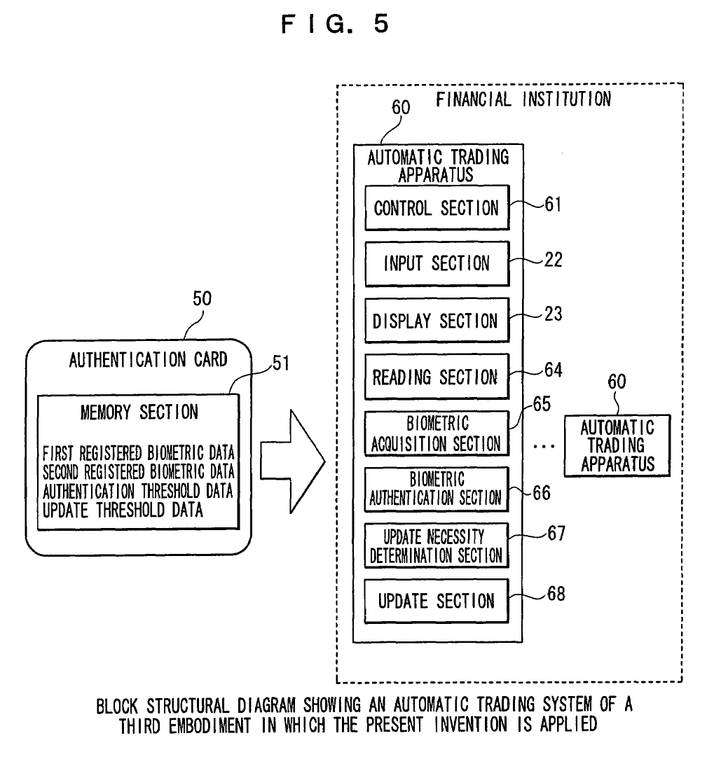

FIG. 5 is a block structural diagram showing an automatic trading system of the third embodiment in which the present invention is applied.

As shown in FIG. 5, the automatic trading system of the third embodiment is structured with an authentication card 50 and automatic trading apparatuses 60.

The authentication card 50 is an IC card which is required for performing biometric authentication, and includes a memory section 51.

The memory section 51 is, for example, a memory formed with a hard disk drive or the like, and retains first registered biometric data, second registered biometric data, authentication threshold data and update threshold data. In the present embodiment, the first registered biometric data is data which represents a vein characteristic of the right palm of a user and the second registered biometric data is data which represents a vein characteristic of the left palm of the user.

The authentication threshold data are authentication threshold data representing non-match rates between biometric data and the registered biometric data that are standards for success in biometric authentication. The update threshold data are data representing non-match rates between the biometric data and the registered biometric data (the first registered biometric data or the second registered biometric data) that are standards for updates of the registered biometric data being required. The authentication threshold data and update threshold data are obtained by experiment at the design stage.

In the present embodiment, the first registered biometric data and the second registered biometric data are both data representing the same kind of vein characteristic. However, it is not limited to this. Different kinds of biometric characteristics may be used, such as, for example, the first registered biometric data being data which represents a vein characteristic of the right palm of a user and the second registered biometric data being data which represents an iris characteristic of an eye of the user.

Moreover, in the present embodiment, while the registered biometric data is data representing vein characteristics of a user, it is not limited to this. The biometric data may be any kind of data that represents biometric characteristics of the user, such as, for example, fingerprint, irises, the face or the like.

The automatic trading apparatus 60 is disposed at a financial institution or the like, and is a device which performs biometric authentication of users and performs desired trading processing, such as deposits and the like, for users for whom biometric authentication is successful. The automatic trading apparatus 60 includes a control section 61, the input section 22 formed with a touch panel or the like, the display section 23 formed with a liquid crystal display or the like, a reading section 64, a biometric acquisition section 65, a biometric authentication section 66, an update necessity determination section 67 and an update section 68. The input section 22 and the display section 23 are the same as in the first embodiment.

The reading section 64 is a section, such as, for example, an IC card reader/writer or the like, which acquires registered biometric data and the like of the user from the authentication card 50 that is inserted thereat. The user refers to an insertion instruction screen and inserts the authentication card 50 at the reading section 64, and the reading section 64 reads the inserted authentication card 50 and acquires each of the first registered biometric data, the second registered biometric data, the authentication threshold data and the update threshold data from the memory section 51.

The control section 61, being a CPU, is a section which performs overall control of the automatic trading apparatus 60. When the reading section 64 acquires the first registered biometric data, etc. as described above, the control section 61 temporarily stores the acquired sets of data at an unillustrated memory.

The biometric acquisition section 65 is a section, such as, for example, biometric sensors or the like, which acquires biometric data representing biometric characteristics such as vein patterns or the like from the user. Similarly to the first embodiment, when the biometric acquisition section 65 receives a biometric acquisition instruction signal, the biometric acquisition section 65 acquires both first biometric data and second biometric data, which represent vein pattern characteristics, from the two palms of the user, which have been placed at predetermined positions. In the present embodiment, the first biometric data that is acquired represents a vein characteristic of the right palm of the user and the second biometric data that is acquired represents a vein characteristic of the left palm of the user.

For the present embodiment, the biometric acquisition section 65 is structured to acquire respective biometric data sets representing characteristics of veins in the right palm and the left palm of the user. However, it is not limited to this. Any kind of data can be used that represent biometric characteristics of the user, such as, for example, fingerprints, iris scans, facial structure and the like.

The biometric authentication section 66 is a section which performs biometric authentication of the user. When the biometric acquisition section 65 has acquired each of the first biometric data and the second biometric data as described above, the biometric authentication section 66 first compares the acquired first biometric data with the first registered biometric data in the memory, and generates first non-match rate data which represents a rate of non-match between the two sets of data. If the generated first non-match rate data is larger than the authentication threshold data, a biometric authentication failure is determined.

When the biometric authentication section 66 determines a biometric authentication failure, the control section 61 causes a biometric authentication failure screen to be displayed at the display section 23 in accordance with biometric authentication failure screen data in the memory.

On the other hand, if the generated first non-match rate data is smaller than the authentication threshold data, the biometric authentication section 66 then compares the acquired second biometric data with the second registered biometric data in the memory, and generates second non-match rate data which represents a rate of non-match between the two sets of data. If the generated second non-match rate data is larger than the authentication threshold data, a biometric authentication failure is determined, but if smaller, a biometric authentication success is determined.

If the biometric authentication section 66 determines a biometric authentication failure, the control section 61 causes the biometric authentication failure screen to be displayed at the display section 23 in accordance with the biometric authentication failure screen data in the memory.

On the other hand, when the biometric authentication section 66 determines a biometric authentication success, the control section 61 outputs a determination instruction signal to the update necessity determination section 67, to cause the update necessity determination section 67 to determine update necessities of the first registered biometric data and the second registered biometric data.

When the update necessity determination section 67 receives the determination instruction signal, the update necessity determination section 67 first compares the generated first non-match rate data with the update threshold data in the memory. If the first non-match rate data is larger than the update threshold data, an update of the first registered biometric data is determined to be necessary, but if smaller, an update is determined to be unnecessary.

The update necessity determination section 67 then compares the generated second non-match rate data with the update threshold data in the memory. If the second non-match rate data is larger than the update threshold data, an update of the second registered biometric data is determined to be necessary, but if smaller, an update is determined to be unnecessary.

If the update necessity determination section 67 determines that no update is necessary for either of the two registered biometric data sets (the first registered biometric data and the second registered biometric data), the control section 61 outputs a trading commencement signal instructing commencement of trading to an unillustrated trading section, similarly to the first embodiment. Trading processing is executed by the trading section that has received the trading commencement instruction on the basis of information representing trading details that have been selected, similarly to heretofore.

On the other hand, if the update necessity determination section 67 determines that an update, of only the first registered biometric data, is necessary, the control section 61 outputs an update instruction signal, with the first biometric data appended, to the update section 68 in order to update the first registered biometric data retained at the memory section 51 of the authentication card 50. If the update necessity determination section 67 determines that an update of only the second registered biometric data is necessary, the control section 61 outputs an update instruction signal, with the second biometric data appended, to the update section 68 in order to update the second registered biometric data retained at the memory section 51 of the authentication card 50. If the update necessity determination section 67 determines that updates of both the registered biometric data sets (the first registered biometric data and the second registered biometric data) are necessary, the control section 61 outputs an update instruction signal, with both the first registered biometric data and the second biometric data appended, to the update section 68 in order to update each of the first and second registered biometric data retained at the memory section 51 of the authentication card 50.

The update section 68 is a section which performs updates of the registered biometric data (the first and second registered biometric data) retained in the memory section 51. If just the first biometric data is appended to an update instruction signal, the update section 68 updates the first registered biometric data at the memory section 51 in accordance with the appended first biometric data. If just the second biometric data is appended to an update instruction signal, the update section 68 updates the second registered biometric data at the memory section 51 in accordance with the appended second biometric data. If the first biometric data and the second biometric data are appended to an update instruction signal, the update section 68 updates both the first registered biometric data and the second registered biometric data at the memory section 51 in accordance with the first biometric data and the second biometric data, respectively. Thereafter, operations are the same as for the first embodiment.

### Operation of the Third Embodiment

Below, operation of the automatic trading system of the third embodiment will be described.

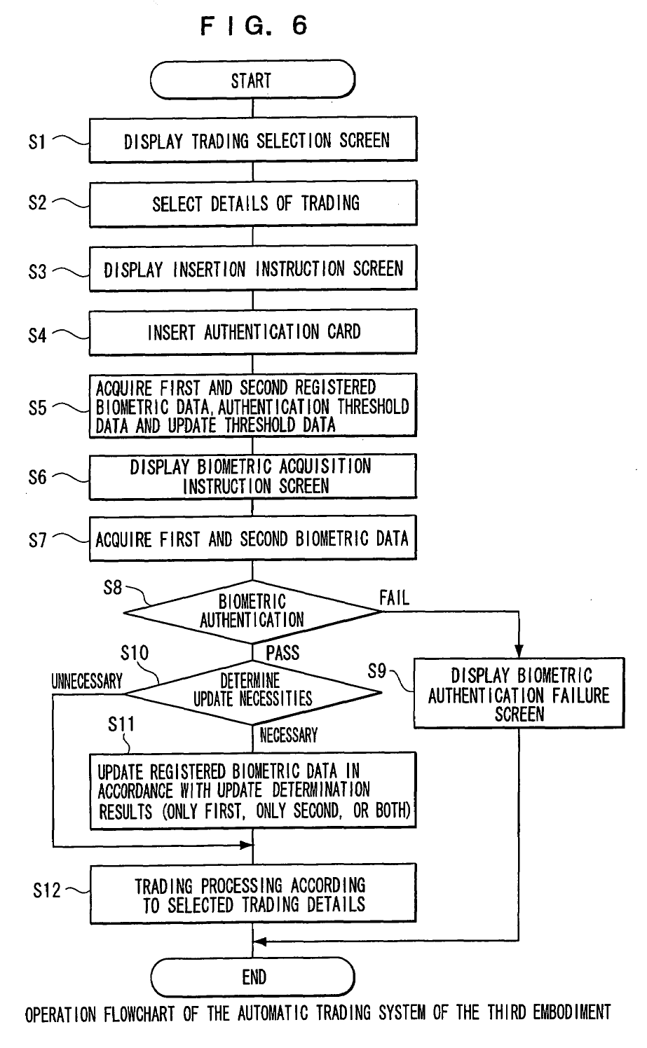

FIG. 6 is an operation flowchart of the automatic trading system of the third embodiment.

The control section 61 of the automatic trading apparatus 60 causes a trading selection screen to be displayed at the display section 23 as an initial screen, in accordance with trading selection screen data in the memory (S1).

The user refers to the trading selection screen and selects desired trading details via the input section 22 (S2). In response, the control section 61 causes the insertion instruction screen to be displayed at the display section 23 in accordance with insertion instruction screen data in the memory (S3).

The user refers to the insertion instruction screen and inserts the authentication card 50 at the reading section 64 (S4). In response, the reading section 64 reads the inserted authentication card 50 and acquires each of the first registered biometric data, the second registered biometric data, the authentication threshold data and the update threshold data from the memory section 51 (S5).

When the reading section 64 acquires each of the first registered biometric data, etc., the control section 61 temporarily stores the acquired data sets in the unillustrated memory. In order to acquire biometric data (i.e., first biometric data and second biometric data) from the user, a biometric acquisition instruction screen is displayed at the display section 23 in accordance with biometric acquisition instruction screen data in the memory (S6).

The user refers to the biometric acquisition instruction screen, places their palms at the predetermined positions and gives an instruction for the acquisition of biometric data via the input section 22. In response, the control section 61 outputs a biometric acquisition instruction signal to the biometric acquisition section 65.

When the biometric acquisition section 65 receives the biometric acquisition instruction signal, the biometric acquisition section 65 acquires both first and second biometric data, representing vein characteristics, from the two palms of the user which have been set at the predetermined positions (S7).

In the present embodiment, the biometric acquisition section 65 is structured to acquire respective biometric data sets (the first and second biometric data) representing vein characteristics of the palms of the user. However, it is not limited to this. Any kind of data sets may be used that represent biometric characteristics of the user, such as, for example, fingerprints, irises, the face and the like.

When the biometric acquisition section 65 acquires each of the first biometric data and the second biometric data, the biometric authentication section 66 first compares the acquired first biometric data with the first registered biometric data in the memory, and generates the first non-match rate data representing a rate of non-match between the two sets of data. If the first non-match rate data that is generated is larger than the authentication threshold data, the biometric authentication is determined to be failed (S8).

If the biometric authentication section 66 determines a biometric authentication failure, the control section 61 causes the biometric authentication failure screen to be displayed at the display section 23 in accordance with the biometric authentication failure screen data in the memory (S9).

On the other hand, if the first non-match rate data that is generated is smaller than the authentication threshold data, the biometric authentication section 66 then compares the acquired second biometric data with the second registered biometric data in the memory, and generates the second non-match rate data representing a rate of non-match between the two sets of data. If the second non-match rate data that is generated is larger than the authentication threshold data, the biometric authentication is determined to be failed, but if smaller, the biometric authentication is determined to be successful.

If the biometric authentication section 66 determines a biometric authentication failure, the control section 61 causes the biometric authentication failure screen to be displayed at the display section 23 in accordance with the biometric authentication failure screen data in the memory.

On the other hand, if the biometric authentication section 66 determines a biometric authentication success, the control section 61 outputs the determination instruction signal to the update necessity determination section 67 to determine update necessities for the first registered biometric data and the second registered biometric data.

When the update necessity determination section 67 receives the determination instruction signal, the update necessity determination section 67 first compares the first non-match rate data that has been generated with the update threshold data in the memory. If the first non-match rate data is larger than the update threshold data, an update of the first registered biometric data is determined to be necessary, but if smaller, an update is determined to be unnecessary.

The update necessity determination section 67 then compares the second non-match rate data that has been generated with the update threshold data in the memory. If the second non-match rate data is larger than the update threshold data, an update of the second registered biometric data is determined to be necessary, but if smaller, an update is determined to be unnecessary (S10).

If the update necessity determination section 67 determines that neither of the two registered biometric data sets (the first registered biometric data and the second registered biometric data) needs updating, the control section 61 outputs the trading commencement signal instructing commencement of trading to the unillustrated trading section, similarly to the first embodiment. Consequent to the trading section receiving the trading commencement signal, trading processing is executed in accordance with information representing the selected trading details, similarly to heretofore (S12).

On the other hand, if the update necessity determination section 67 determines that an update of only the first registered biometric data is necessary, the control section 61 outputs the update instruction signal with the first biometric data attached to the update section 68 in order to update the first registered biometric data retained at the memory section 51 of the authentication card 50. If the update necessity determination section 67 determines that an update of only the second registered biometric data is necessary, the control section 61 outputs the update instruction signal with the second biometric data attached to the update section 68 in order to update the second registered biometric data retained at the memory section 51 of the authentication card 50. And if the update necessity determination section 67 determines that updates of both the registered biometric data sets (the first registered biometric data and the second registered biometric data) are necessary, the control section 61 outputs the update instruction signal with both the first registered biometric data and the second biometric data attached to the update section 68 in order to update each of the first and second registered biometric data retained at the memory section 51 of the authentication card 50.

The update section 68 is the section which performs updates of the registered biometric data sets (the first and second registered biometric data) in the memory section 51. If only the first biometric data is attached to the update instruction signal, the update section 68 updates the first registered biometric data at the memory section 51 on the basis of the attached first biometric data. If only the second biometric data is attached to the update instruction signal, the update section 68 updates the second registered biometric data at the memory section 51 on the basis of the attached second biometric data. And if the first biometric data and the second biometric data are attached to the update instruction signal, the update section 68 updates both the first registered biometric data and the second registered biometric data at the memory section 51 on the basis of the attached first biometric data and second biometric data, respectively (S11). Trading processing desired by the user is executed in the same manner as in the first embodiment (S12).

### Effects of the Third Embodiment

In the automatic trading system of the third embodiment, when biometric authentication is determined to be successful, first non-match rate data, which represents a rate of non-match between first biometric data acquired from a user and first registered biometric data acquired from the authentication card 50, is compared with update threshold data, which represents a non-match rate between biometric data and registered biometric data that is a standard for updating the registered biometric data. If the first non-match rate data is larger than the update threshold data, an update is determined to be necessary. Second non-match rate data, which represents a rate of non-match between second biometric data acquired from a user and second registered biometric data acquired from the authentication card 50, is compared with the update threshold data, and if the second non-match rate data is larger than the update threshold data, an update is determined to be necessary. The first registered biometric data and/or second registered biometric data retained at the authentication card 50 is/are updated on the basis of the acquired first biometric data and/or second biometric data. Thus, the first registered biometric data and the second registered biometric data can be updated only when there is a large change with aging. Therefore, unnecessary updating of the registered biometric data can be prevented.

### Fourth Embodiment

### Structure of the Fourth Embodiment

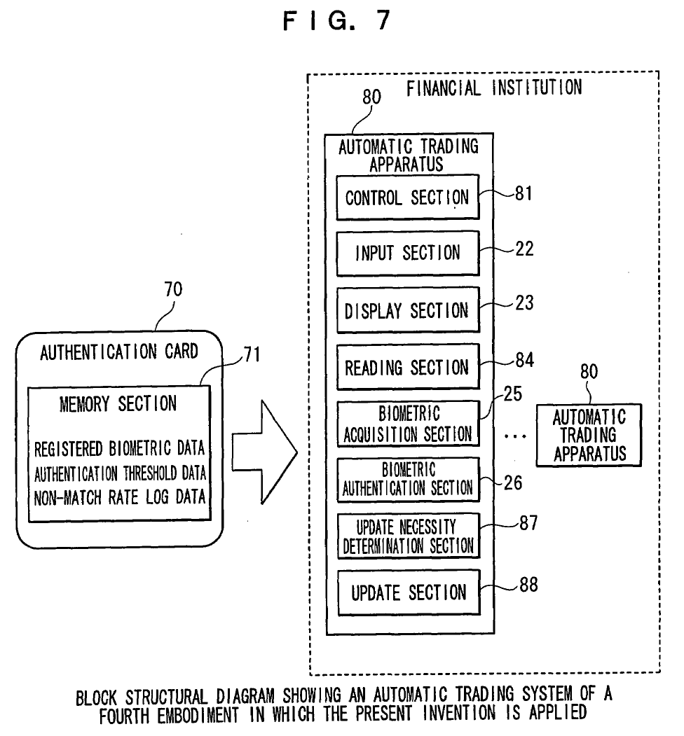

FIG. 7 is a block structural diagram showing an automatic trading system of the fourth embodiment in which the present invention is applied.

As shown in FIG. 7, the automatic trading system of the fourth embodiment is structured with an authentication card 70 and automatic trading apparatuses 80.

The authentication card 70 is an IC card which is required for performing biometric authentication, and includes a memory section 71.

The memory section 71 is, for example, a memory formed with a hard disk drive or the like. The memory section 71 retains registered biometric data, which represents a biometric characteristic such as a vein pattern or the like of a user, which was registered when the IC card was issued, and the memory section 71 retains authentication threshold data and non-match rate log data, which represents non-match rates at previous times of biometric authentication. The authentication threshold data is authentication threshold data representing a non-match rate between biometric data and the registered biometric data that is a standard for success in biometric authentication. The authentication threshold data is obtained by experiment at the design stage. The non-match rate log data is stored, in a pre-specified plurality of frames, in a recent time sequence of occasions when matching was performed. When the plural frames have been filled up, the frames are subsequently overwritten with the most recent data. That is, at any time, a plurality of the most recent data for the current point in time are stored in order.

The automatic trading apparatus 80 is disposed at a financial institution or the like, and is a device which performs biometric authentication of users and performs desired trading processing, such as deposits and the like, for users for whom biometric authentication is successful. The automatic trading apparatus 80 includes a control section 81, the input section 22 formed with a touch panel or the like, the display section 23 formed with a liquid crystal display or the like, a reading section 84, the biometric acquisition section 25, the biometric authentication section 26, an update necessity determination section 87 and an update section 88. The input section 22, the display section 23, the biometric acquisition section 25 and the biometric authentication section 26 are the same as in the first embodiment.

The reading section 84 is a section, such as, for example, an IC card reader/writer or the like, which acquires registered biometric data, authentication threshold data and non-match rate log data of the user from the authentication card 70 that is inserted thereat. Similarly to the first embodiment, the user refers to an insertion instruction screen and inserts the authentication card 70 at the reading section 84, and the reading section 84 reads the inserted authentication card 70 and acquires each of the registered biometric data, the authentication threshold data and the non-match rate log data from the memory section 71.

The control section 81, being a CPU, is a section which performs overall control of the automatic trading apparatus 80. When the reading section 84 acquires the registered biometric data, etc. as described above, the control section 81 temporarily stores the acquired sets of data at an unillustrated memory.

The biometric authentication section 26 is a section which performs biometric authentication of the user. When the biometric acquisition section 25 acquires the biometric data in a similar manner to the first embodiment, the biometric authentication section 26 compares the acquired biometric data with the registered biometric data in the memory, and generates non-match rate data which represents a rate of non-match between the two sets of data. If the generated non-match rate data is smaller than the authentication threshold data, a biometric authentication success is determined, but if larger, a biometric authentication failure is determined.

When the biometric authentication section 26 determines a biometric authentication failure, the control section 81 causes a biometric authentication failure screen to be displayed at the display section 23 in accordance with biometric authentication failure screen data in the memory.

On the other hand, when the biometric authentication section 26 determines a biometric authentication success, the control section 81 outputs a determination instruction signal to the update necessity determination section 87, to cause the update necessity determination section 87 to determine an update necessity of the registered biometric data.

The update necessity determination section 87 is a section which determines whether or not the registered biometric data needs updating. When the update necessity determination section 87 receives the determination instruction signal, if the generated non-match rate data is smaller than the authentication threshold data, the update necessity determination section 87 refers to the plurality of most recent non-match rate log data. If it is judged that non-match rate data has been approaching the authentication threshold data with the passage of time, the update necessity determination section 87 determines that an update is necessary.

If the update necessity determination section 87 determines that an update is unnecessary, the control section 81 outputs a trading commencement signal instructing commencement of trading to an unillustrated trading section. Trading processing is executed by the trading section that has received the trading commencement instruction on the basis of information representing trading details that have been selected, similarly to heretofore.

On the other hand, if the update necessity determination section 87 determines that an update is necessary, the control section 81 outputs an update instruction signal, with the biometric data and the non-match rate data appended, to the update section 88 in order to update the registered biometric data and the non-match rate log data retained at the memory section 71 of the authentication card 70.

The update section 88 is a section which performs an update of the registered biometric data and the non-match rate log data retained in the memory section 71 of the authentication card 70. When the update section 88 receives the update instruction signal, the update section 88 updates the registered biometric data at the memory section 71 in accordance with the appended biometric data, and overwrites the non-match rate log data from the longest time ago with the most recent non-match rate log data. Thereafter, operations are the same as for the first embodiment.

### Operation of the Fourth Embodiment

Below, operation of the automatic trading system of the fourth embodiment will be described.

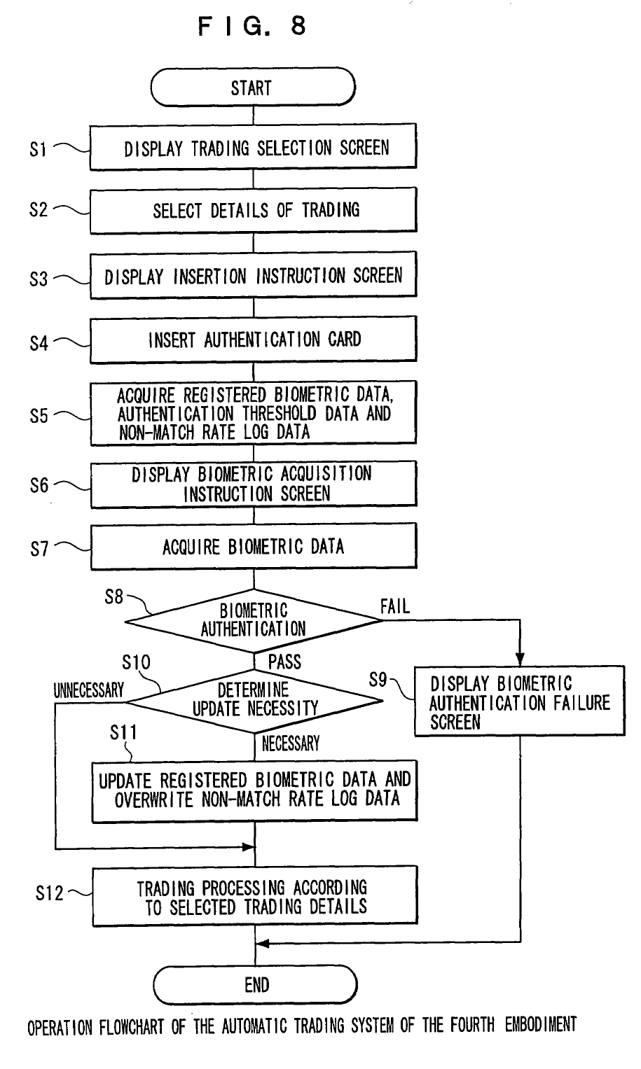

FIG. 8 is an operation flowchart of the automatic trading system of the fourth embodiment.

The control section 81 of the automatic trading apparatus 80 causes a trading selection screen to be displayed at the display section 23 as an initial screen, in accordance with trading selection screen data in the memory (S1).

The user refers to the trading selection screen and selects desired trading details via the input section 22 (S2). In response, the control section 81 causes the insertion instruction screen to be displayed at the display section 23 in accordance with insertion instruction screen data in the memory (S3).

The user refers to the insertion instruction screen and inserts the authentication card 70 at the reading section 84 (S4). In response, the reading section 84 reads the inserted the authentication card 70 and acquires each of the registered biometric data, the authentication threshold data and the non-match rate log data from the memory section 71 (S5).

When the reading section 84 acquires each of the registered biometric data, the authentication threshold data and the non-match rate log data, the control section 81 temporarily stores the acquired registered biometric data, authentication threshold data and non-match rate log data in an unillustrated memory. In order to acquire biometric data from the user, a biometric acquisition instruction screen is displayed at the display section 23 in accordance with biometric acquisition instruction screen data in the memory (S6).

The user refers to the biometric acquisition instruction screen, places their palm at a predetermined position, and gives an instruction for the acquisition of biometric data via the input section 22. In response, the control section 81 outputs a biometric acquisition instruction signal to the biometric acquisition section 25.

When the biometric acquisition section 25 receives the biometric acquisition instruction signal, the biometric acquisition section 25 acquires biometric data representing a vein characteristic from the palm of the user which has been set at the predetermined position (S7).

In the present embodiment, the biometric data that the biometric acquisition section 25 acquires the biometric data representing a characteristic of veins in the palm of a hand of a user. However, it is not limited to this. The biometric data may be any kind of data that represents a biometric characteristic of the user, such as, for example, a fingerprint, an iris, the face or the like.

When the biometric acquisition section 25 has acquired the biometric data, the biometric authentication section 26 compares the acquired biometric data with the registered biometric data in the memory, and generates the non-match rate data representing a rate of non-match between the two sets of data. If the non-match rate data that is generated is larger than the authentication threshold data, the biometric authentication is determined to be failed, and if smaller, the biometric authentication is determined to be successful (S8).

If the biometric authentication section 26 determines a biometric authentication failure, the control section 81 causes the biometric authentication failure screen to be displayed at the display section 23 in accordance with the biometric authentication failure screen data in the memory (S9).

On the other hand, if the biometric authentication section 26 determines a biometric authentication success, the control section 81 outputs the determination instruction signal to the update necessity determination section 87 to determine an update necessity for the registered biometric data.

The update necessity determination section 87 examines the plurality of the most recent non-match rate log data. If it is judged that the non-match rate log data has been approaching the authentication threshold data as time passes, an update is determined to be necessary. In other cases, an update is determined to be unnecessary (S10).

If the update necessity determination section 87 determines that an update is unnecessary, the control section 81 outputs the trading commencement signal instructing commencement of trading to the unillustrated trading section. Trading processing is executed by the trading section that has received the trading commencement instruction, on the basis of information representing the trading details that have been selected, similarly to heretofore (S12).

On the other hand, if the update necessity determination section 87 determines that an update is necessary, the control section 81 outputs the update instruction signal, with the biometric data and the non-match rate data attached, to the update section 88 in order to update the registered biometric data and overwrite the non-match rate log data retained at the memory section 71 of the authentication card 70.

When the update section 88 receives the update instruction signal, the update section 88 updates the registered biometric data at the memory section 71 in accordance with the attached biometric data, and overwrites the non-match rate log data from the longest time ago in accordance with the most recent non-match rate data (S11). Thereafter, operations are the same as in the first embodiment.

### Effects of the Fourth Embodiment

In the automatic trading system of the fourth embodiment, when biometric authentication is determined to be successful, the update necessity determination section 87 examines a plurality of most recent non-match rate log data. If it is judged that the non-match rate log data has come close to an authentication threshold data with the passage of time, it is determined that an update is necessary. Registered biometric data is updated on the basis of the result of this determination. Therefore, unnecessary updating of the registered biometric data can be prevented.

For the embodiments described above, descriptions have been given with the present invention being applied to an automatic trading system. However, the present invention is not limited thus. The present invention may be applied to any system provided that system performs biometric authentication.

The embodiments described above have structures in which authentication threshold data, which is used in biometric authentication, is retained at a memory section of an authentication card. However, the present invention is not limited thus. Structures are possible in which authentication threshold data is retained at an automatic trading apparatus.

For the embodiments described above, descriptions have been given with an IC card being employed as an authentication card. However, the present invention is not limited thus. The authentication card may have any form provided it can memorize registered biometric data and the like, such as, for example, a magnetic card or the like.

Embodiments of the present invention are described above, but the present invention is not limited to the embodiments as will be clear to those skilled in the art.

According to an aspect of the invention, there is provided a biometric data update system that generates non-match rate data representing a rate of non-match between biometric data and registered biometric data, the biometric data representing a biometric characteristic of a user and the registered biometric data having been registered in advance as a matching object, and determines that biometric authentication is successful if the non-match rate data is smaller than authentication threshold data which represents a non-match rate that is a standard for success of the biometric authentication between the biometric data and the registered biometric data, the system comprising: an authentication card that retains at least the registered biometric data and update threshold data, the update threshold data representing the non-match rate between the biometric data and the registered biometric data; a reading section that acquires the registered biometric data and the update threshold data from the authentication card; an update necessity determination section that, if the biometric authentication is determined to be successful, compares the non-match rate data with the acquired update threshold data and, if the non-match rate data is larger than the update threshold data, determines that an update is necessary; and an update section that, if the update is determined to be necessary, updates the registered biometric data retained at the authentication card on the basis of the acquired biometric data.

According to a second aspect of the invention, there is provided a biometric data update system that generates non-match rate data representing a rate of non-match between biometric data and registered biometric data, the biometric data representing a biometric characteristic of a user and the registered biometric data having been registered in advance as a matching object, and determines that biometric authentication is successful if the non-match rate data is smaller than authentication threshold data which represents a non-match rate that is a standard for success of the biometric authentication between the biometric data and the registered biometric data, the system comprising: an authentication card that retains at least the registered biometric data and update time data, the update time data representing a time at which the registered biometric data was registered; update interval data representing an interval of elapsed time for updating the registered biometric data; a reading section that acquires the registered biometric data and the update time data from the authentication card; a time acquisition section that, if the biometric authentication is determined to be successful, generates current time data representing a current time; an update necessity determination section that, when the current time data has been generated, generates elapsed interval data representing an interval of elapsed time from the update time to the current time on the basis of the acquired update time data and the current time data and, if the generated elapsed interval data is larger than the update interval data, determines that an update is necessary; and an update section that, if the update is determined to be necessary, updates the registered biometric data retained at the authentication card on the basis of the acquired biometric data and updates the update time data on the basis of the current time data.

According to a third aspect of the invention, there is provided a biometric data update system that compares first biometric data representing a biometric characteristic of a user with first registered biometric data and compares second biometric data representing a biometric characteristic of the user with second registered biometric data, the first and second registered biometric data having been registered in advance as matching objects, generates first non-match rate data representing a rate of non-match between the first biometric data and the first registered biometric data and generates second non-match rate data representing a rate of non-match between the second biometric data and the second registered biometric data, and determines that biometric authentication is successful if each of the first and second non-match rate data is smaller than authentication threshold data, which represent non-match rates that are standards for success of the biometric authentication, the system comprising: an authentication card that retains at least the first registered biometric data, the second registered biometric data and update threshold data, the update threshold data representing non-match rates that are standards for updating the first and second registered biometric data; a reading section that acquires the first registered biometric data, the second registered biometric data and the update threshold data from the authentication card; an update necessity determination section that, if the biometric authentication is determined to be successful, compares the first non-match rate data with the update threshold data and, if the first non-match rate data is larger than the update threshold data, determines that an update of the first registered biometric data is necessary, and compares the second non-match rate data with the update threshold data and, if the second non-match rate data is larger than the update threshold data, determines that an update of the second registered biometric data is necessary; and an update section that, if an update of the first registered biometric data is determined to be necessary, updates the first registered biometric data retained at the authentication card on the basis of the acquired first biometric data and, if an update of the second registered biometric data is determined to be necessary, updates the second registered biometric data retained at the authentication card on the basis of the acquired second biometric data.

According to a fourth aspect of the invention, there is provided a biometric data update system that generates non-match rate data representing a rate of non-match between biometric data and registered biometric data, the biometric data representing a biometric characteristic of a user and the registered biometric data having been registered in advance as a matching object, and determines that biometric authentication is successful if the non-match rate data is smaller than authentication threshold data which represents a non-match rate that is a standard for success of the biometric authentication between the biometric data and the registered biometric data, the system comprising: an authentication card that retains at least the registered biometric data and non-match rate log data, the non-match rate log data representing at least a most recent non-match rate between the biometric data and the registered biometric data at a time at which the biometric authentication was successfully completed; a reading section that acquires the registered biometric data and the non-match rate log data from the authentication card; an update necessity determination section that, if the biometric authentication is determined to be successful, refers to the non-match rate log data and, if the non-match rate log data is judged to be approaching the authentication threshold data, determines that an update of the registered biometric data is necessary; and an update section that, if the update is determined to be necessary, updates the registered biometric data retained at the authentication card on the basis of the acquired biometric data.

According to the aspects described above, when a biometric authentication is determined to be successful, non-match rate data, which represents a level of non-match between biometric data acquired from a user and registered biometric data acquired from an authentication card, is compared with update threshold data, which represents a level of non-match between the biometric data and the registered biometric data that is a standard for updating the registered biometric data acquired from the authentication card. If the non-match rate data is larger than the update threshold data, an update is determined to be necessary, and the registered biometric data retained at the authentication card is updated on the basis of the biometric data that has been acquired. Thus, the registered biometric data can be updated only when there is a large change with aging. Therefore, unnecessary updating of the registered biometric data can be avoided.

What is claimed is:

1. A biometric data update system that
generates non-match rate data representing a rate of non-match between biometric data and registered biometric data, the biometric data representing a biometric characteristic of a user and the registered biometric data having been registered in advance as a matching object, and
determines that biometric authentication is successful if the non-match rate data is smaller than authentication threshold data which represents a non-match rate that is a standard for success of the biometric authentication between the biometric data and the registered biometric data,
the system comprising:
an authentication card that retains at least the registered biometric data and update threshold data, the update threshold data representing the non-match rate between the biometric data and the registered biometric data;
a reading section that acquires the registered biometric data and the update threshold data from the authentication card;
an update necessity determination section that, if the biometric authentication is determined to be successful, compares the non-match rate data with the acquired update threshold data and, if the non-match rate data is larger than the update threshold data, determines that an update is necessary; and
an update section that, if the update is determined to be necessary, updates the registered biometric data retained at the authentication card on the basis of the acquired biometric data.

2. The biometric data update system of claim 1, wherein the authentication card further retains the authentication threshold data,
the reading section further acquires the authentication threshold data, and
the system further comprises a biometric authentication section which generates the non-match rate data which represents the rate of non-match between the biometric data and the registered biometric data, and determines that the biometric authentication is successful if the non-match rate data is smaller than the authentication threshold data which represents the rate of non-match that is the standard for success of the biometric authentication between the biometric data and the registered biometric data.

3. The biometric data update system of claim 2, further comprising a biometric acquisition section that acquires the biometric data.

4. A biometric data update system that
generates non-match rate data representing a rate of non-match between biometric data and registered biometric data, the biometric data representing a biometric characteristic of a user and the registered biometric data having been registered in advance as a matching object, and
determines that biometric authentication is successful if the non-match rate data is smaller than authentication threshold data which represents a non-match rate that is a standard for success of the biometric authentication between the biometric data and the registered biometric data,
the system comprising:
an authentication card that retains at least the registered biometric data and update time data, the update time data representing a time at which the registered biometric data was registered;
update interval data representing an interval of elapsed time for updating the registered biometric data;
a reading section that acquires the registered biometric data and the update time data from the authentication card;
a time acquisition section that, if the biometric authentication is determined to be successful, generates current time data representing a current time;
an update necessity determination section that, when the current time data has been generated, generates elapsed interval data representing an interval of elapsed time from the update time to the current time on the basis of the acquired update time data and the current time data and, if the generated elapsed interval data is larger than the update interval data, determines that an update is necessary; and
an update section that, if the update is determined to be necessary, updates the registered biometric data retained at the authentication card on the basis of the acquired biometric data and updates the update time data on the basis of the current time data.

5. A biometric data update system that
compares first biometric data representing a biometric characteristic of a user with first registered biometric data and compares second biometric data representing a biometric characteristic of the user with second registered biometric data, the first and second registered biometric data having been registered in advance as matching objects,
generates first non-match rate data representing a rate of non-match between the first biometric data and the first registered biometric data and generates second non-match rate data representing a rate of non-match between the second biometric data and the second registered biometric data, and
determines that biometric authentication is successful if each of the first and second non-match rate data is smaller than authentication threshold data, which represent non-match rates that are standards for success of the biometric authentication,
the system comprising:
an authentication card that retains at least the first registered biometric data, the second registered biometric data and update threshold data, the update threshold data representing non-match rates that are standards for updating the first and second registered biometric data;
a reading section that acquires the first registered biometric data, the second registered biometric data and the update threshold data from the authentication card;
an update necessity determination section that, if the biometric authentication is determined to be successful,
compares the first non-match rate data with the update threshold data and, if the first non-match rate data is larger than the update threshold data, determines that an update of the first registered biometric data is necessary, and
compares the second non-match rate data with the update threshold data and, if the second non-match rate data is larger than the update threshold data, determines that an update of the second registered biometric data is necessary; and
an update section that
if an update of the first registered biometric data is determined to be necessary, updates the first registered biometric data retained at the authentication card on the basis of the acquired first biometric data, and
if an update of the second registered biometric data is determined to be necessary, updates the second registered biometric data retained at the authentication card on the basis of the acquired second biometric data.

6. A biometric data update system that
generates non-match rate data representing a rate of non-match between biometric data and registered biometric data, the biometric data representing a biometric characteristic of a user and the registered biometric data having been registered in advance as a matching object, and
determines that biometric authentication is successful if the non-match rate data is smaller than authentication threshold data which represents a non-match rate that is a standard for success of the biometric authentication between the biometric data and the registered biometric data, the system comprising:
an authentication card that retains at least the registered biometric data and non-match rate log data, the non-match rate log data representing at least a most recent non-match rate between the biometric data and the registered biometric data at a time at which the biometric authentication was successfully completed;
a reading section that acquires the registered biometric data and the non-match rate log data from the authentication card;
an update necessity determination section that, if the biometric authentication is determined to be successful, refers to the non-match rate log data and, if the non-match rate log data is judged to be approaching the authentication threshold data, determines that an update of the registered biometric data is necessary; and
an update section that, if the update is determined to be necessary, updates the registered biometric data retained at the authentication card on the basis of the acquired biometric data.

7. The biometric data update system of claim 6, wherein the authentication card comprises a plurality of recent non-match rate log data which comprise the non-match rate log data of the most recent non-match rate, and
the update necessity determination section, if the biometric authentication is determined to be successful, refers to the plurality of recent non-match rate log data and, if the non-match rate log data are judged to be approaching the authentication threshold data with the passage of time, determines that the update of the registered biometric data is necessary.
